(19) United States
(12) Patent Application Publication
(10) Pub. No.: US 2019/0004998 A1
(43) Pub. Date: Jan. 3, 2019

(54) SPARSE MATRIX REPRESENTATION

(71) Applicant: Seagate Technology LLC, Cupertino, CA (US)

(72) Inventor: Kevin A. Gomez, Eden Prairie, MN (US)

(21) Appl. No.: 16/025,159

(22) Filed: Jul. 2, 2018

Related U.S. Application Data
(60) Provisional application No. 62/527,685, filed on Jun. 30, 2017.

(51) Int. Cl. G06F 17/16; G06F 17/30

(52) U.S. Cl. CPC G06F 17/16; G06F 17/30504; G06F 17/30315

(57) ABSTRACT

A representation of a sparse matrix is generated that includes a value array, a column array, a pointer array, and a row array. The value array includes the nonzero elements of the sparse matrix. The column array includes a column number where a value is located in the sparse matrix. Elements of the pointer array indicate indices of the value array that start a new row in the sparse matrix. Elements of the row array indicate rows that include nonzero or nonempty elements.

### PRIORITY CLAIM

The present application claims benefit of priority to U.S. Patent Application Ser. No. 62/527,685, filed on Jun. 30, 2017 and titled “Sparse Matrix Representation,” which is hereby incorporated by reference in its entirety.

### BACKGROUND

Matrices are used to represent relationships between different data points. These relationships may be economic relationships, chemical relationships, biological relationships, technological relationships, etc. Matrices are generally represented in computer systems using two-dimensional arrays. Sparse matrices types of matrices where most elements are zero (or empty). Operations utilizing sparse matrices as represented by two-dimensional arrays are slow an inefficient as memory and processing resources are used on the zero or empty elements.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

In at least one implementation a method includes receiving a sparse matrix including r rows, c columns, and k values and generating a representation of the sparse matrix. The generated representation includes at least a row array, each element of the row array indicating a row number of the r rows of the sparse matrix that includes at least one of the k values.

These and various other features and advantages will be apparent from a reading of the following Detailed Description.

### BRIEF DESCRIPTIONS OF THE DRAWINGS

FIG. 1 illustrates an example implementation of a sparse matrix and a representation of the sparse matrix.

FIG. 2 illustrates another example implementation of a sparse matrix and a representation of the sparse matrix.

FIG. 3 illustrates example operations for generating a representation of a sparse matrix.

FIG. 4 illustrates example operations for querying a representation of a sparse matrix.

FIG. 5 illustrates an example processing system that may be useful in implementing the described technology.

### DETAILED DESCRIPTION

Matrices are used to represent relationships between different data points. These relationships may be economic relationships, chemical relationships, biological relationships, technological relationships, etc. Matrices are generally represented in computer systems using two-dimensional arrays. Sparse matrices types of matrices where most elements are zero (or empty). Operations utilizing sparse matrices as represented by two-dimensional arrays are slow an inefficient as memory and processing resources are used on the zero or empty elements. As such, sparse matrices are sometimes compressed to use less memory and/or to provide more efficient matrix element processing. Sparse matrices may be compressed using different methods such as, for example, a dictionary of keys method, a list of list method, a coordinate list method, a compressed sparse row (CSR) method, or a compressed sparse column (CSC) method. The efficiency/memory of these example methods may be dependent on the sparse matrix dimension (number of rows times number of columns).

Some sparse matrices include complete rows and/or columns that do not have any nonzero elements (e.g., hypersparse matrices). In other words, complete rows or columns may be empty. Implementations described herein provide a method and system for generating a representation of a sparse matrix that accounts for nonempty rows or columns. Thus, resources are not wasted on rows/columns of the sparse matrix that are empty (e.g., include all non-zero elements). A sparse matrix is processed to generate the representation that includes a value array, a column array, a pointer array, and a row array. The value array includes the nonzero elements of the sparse matrix. The column array includes a column number where a value is located in the sparse matrix. Elements of the pointer array indicate indices of the value array that start a new row in the sparse matrix. Elements of the row array indicate rows that include nonzero or nonempty elements. The length of the value array and the column array is equal to the number of nonzero elements. The length of the pointer array and the row array is equal to the number of non-empty rows plus one. Thus, the size/efficiency of the generated representation is on the order of the number of nonzero elements. In a 5 GB sample database, a sparse matrix included 39,190,538 triples with 11,352 distinct predicates and 2,408,915 distinct subjects. In a slice of the sparse matrix, the number of nonzero elements was 3,451, while the matrix dimension (number of rows times number of columns) was 2,408,915. Thus, the implementations described herein provide significant processing/memory resource savings.

Furthermore, the implementations described herein may be achieved using programmable hardware. In other words, an application specific integrated circuit (ASIC) or system on chip (SoC) may be configured to receive a sparse matrix and generate the representation of the sparse matrix. Thus, a special purpose processing unit may be utilized to efficiently generate the matrix representation. After the representation is generated, the queries may be performed on the representation (compressed form) to execute different operations. The representation maybe used for fast row (or column) access and matrix-vector multiplications.

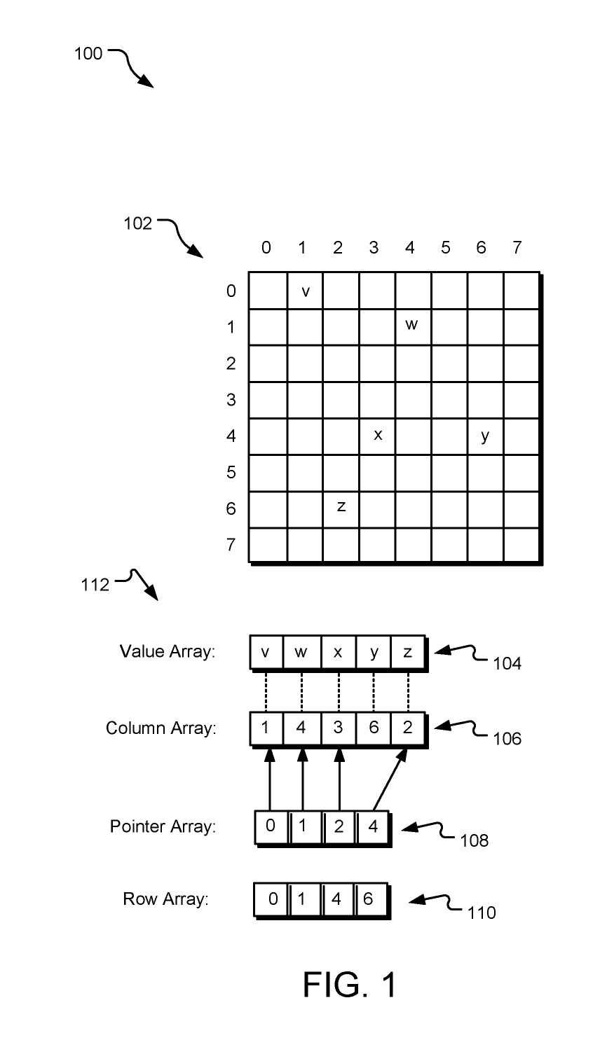

FIG. 1 illustrates an example implementation 100 of a sparse matrix 102 and a representation 112 of the sparse matrix 102. The sparse matrix 102 includes r rows and c columns where r=8 and c=8. It should be understood that the implementations described in may be utilized with different m and n values. The sparse matrix 102 includes k values where the values are represented by “v”, “w,” “x,” “y,” and “z.” The matrix elements that do not include values may hold a value of 0 or may be empty. For example, the matrix element at row 3 and column 5 (3, 5) is empty or has a value of 0. The sparse matrix 102 is converted to the representation 112 of the sparse matrix 102 (hereinafter “representation 112”). The representation 112 does not use as much memory in a computer (not shown) or storage medium (not shown) as the sparse matrix 102. Furthermore, operations utilizing values of the representation 112 may be faster/more efficient than operations utilizing the values of the sparse matrix 102. In other words, the values of the sparse matrix may be accessed (queried) faster using the representation 112.

The representation 112 includes a value array 104, a column array 106, a pointer array 108, and a row array 110. The value array 104 stores the values of the non-zero (or non-empty) elements of the sparse matrix 102 as they are encountered in a row-wise order (left-to-right, top-to bottom). The column array 106 stores the columns where each of the values in the value array 104 are located in the sparse matrix 102. In other words, the column array 106 stores the column indices of the values in the value array 104. Each element in the column array 106 corresponds to the same element in the value array 104. For example, the value “v” appears in the sparse matrix 102 as (0, 1), meaning that value “v” is in row 0 and column 1. Value “v” appears in the value array at value_array[0] and in the column array 106 at column_array[0], which indicates that the value “a” is in column 1 of the sparse matrix 102. Similarly, the column array 106 indicates that the value “w” is in column 4, value “x” is in column 3, etc.

The pointer array 108 stores the locations in the value array 104 and/or the column array 106 that start a new row. In other words, the pointer array 108 stores the location in the value array 104 of the first nonzero element in a row. For example, element 0 in the pointer array points to value “v” (e.g., pointer_array[0] points to value “v” of the value array 104 (value_array[0])). Element 2 in the pointer array indicates that element 2 in the value array 104 starts a new row (e.g., “x” is the first value in the row 3). The next value in the sparse matrix 102 is value “y,” which is in the same row is value “x”. Because “y” is on the same row as “x” there is no value/element for “y” in the pointer array 108. The next element in the pointer array 108 (e.g., pointer array[3]) is 4, which indicates that element 4 in the value array (e.g., value array[4]) is the value that stars the next row. In other words, pointer array[3]=4 and value array[4]=“z,” which indicates that value “z” is the first element in the next row.

The row array 110 indicates rows with nonzero (non-empty) elements in order. The row array 110 indicates that rows 0, 1, 4, and 6 of the sparse matrix 102 include nonzero elements or have a value. Thus, in sparse matrices that include rows without any values, the row array 110 may be used to quickly determine which rows to examine to find values. The row array 110, the pointer array 108, the column array 106, and the value array 104 may be utilized to quickly access values that were included in the sparse matrix 102.

For example, if a user wanted to print the triples (row, column, value) in order (left-to-right, top-to-bottom) as the appear in the sparse matrix 102 using the representation 112, example operations may be:

```
for(i=0; i<value_array.length( ); i++)
  for(k=pointer_array[i]; k < pointer_array[i+1]; k++)
    print (row_array[i], column_array[k], value_array[k])
```

The “print” statement in the above exemplary code would print the triples (row, column, value) as they appear in the sparse matrix 102.

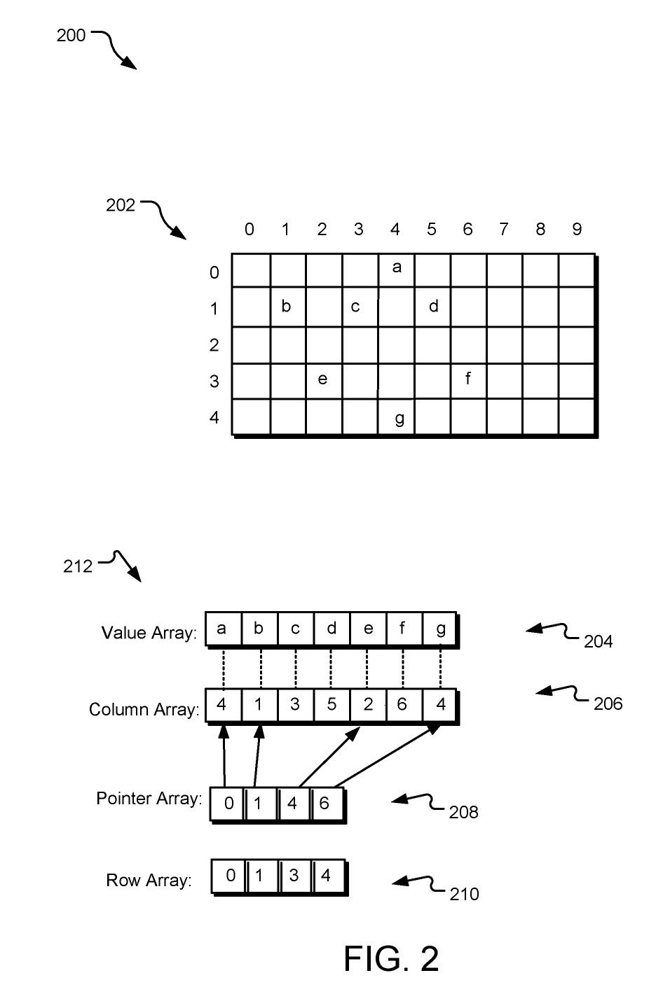

FIG. 2 illustrates an example implementation 200 of a sparse matrix 202 and a representation 212 of the sparse matrix 202. The sparse matrix 202 includes r rows and c columns, where r=5 and c=10. It should be understood that the implementations described in may be utilized with different m and n values. The sparse matrix 202 includes k values where the values are represented by “a”, “b,” “c,” “d,” “e,” “f,” and “g.” The matrix elements that do not include values may hold a value of 0 or may be empty. For example, the matrix element at row 3 and column 5 (3, 5) is empty or has a value of 0. The sparse matrix 202 is converted to the representation 212 of the sparse matrix 202 (hereinafter “representation 212”). The representation 212 does not use as much memory in a computer (not shown) or storage medium (not shown) as the sparse matrix 202. Furthermore, operations utilizing values of the representation 212 may be faster/more efficient than operations utilizing the values of the sparse matrix 202. In other words, the values of the sparse matrix may be accessed (queried) more efficiently using the representation 212.

The representation 212 includes a value array 204, a column array 206, a pointer array 208, and a row array 210. The value array 204 stores the values of the non-zero (or non-empty) elements of the sparse matrix 202 as they are encountered in a row-wise order (left-to-right, top-to bottom). The column array 206 stores the columns where each of the values in the value array 204 appears in the sparse matrix 202. In other words, the column array 206 stores the column indices of the values as they appear in the sparse matrix 202. Each element in the column array 206 corresponds to the same element in the value array 204. For example, the value “a” appears in the sparse matrix 202 as (0, 4), meaning that value “a” is in row 0 and column 4. Value “a” appears in the value array at value array[0] and in the column array 206 at column_array[0]), which indicates that the value “a” is in column 4 of the sparse matrix (e.g., column_array[0]=4). Similarly, the column array 206 indicates that the value “b” is in column 1, value “c” is in column 3, etc.

The pointer array 208 stores the locations in the value array 204 and/or the column array 206 that start a new row. In other words, the pointer array 208 stores the location (index) in the value array 204 of the first nonzero element in a row. For example, the first element (pointer_array[0]) in the pointer array has a value of “0,” which indicates that “a” is the first nonzero element in a row of the sparse matrix 202. The second element in the pointer array (pointer_array[1]) indicates that element 1 in the value array 204 (value_array[1]) starts a new row (e.g., “b” is the first value in a row off the sparse matrix 202). The next element in the pointer array has a value of 4 (pointer_array[2]=4), which indicates the value (“e”) at value_array[4] is the first non-zero element in a row of the sparse matrix 202. In other words, “c” and “d” (value_array[3] and value_array[4]) are on the same row in the sparse matrix as “b.” Similarly, “f” is on the same row in the sparse matrix 202 as “e,” and “g” is the first non-zero element on a row of the sparse matrix 202.

The row array 210 indicates rows with nonzero (non-empty) elements in order. The row array 210 indicates that rows 0, 1, 3, and 4 of the sparse matrix 202 include nonzero elements or have a value. Thus, in sparse matrices that include rows without any values, the row array 210 may be used to quickly determine which rows to examine to find values. The row array 210, the pointer array 208, the column array 206, and the value array 204 may be utilized to quickly access values that were included in the sparse matrix 202.

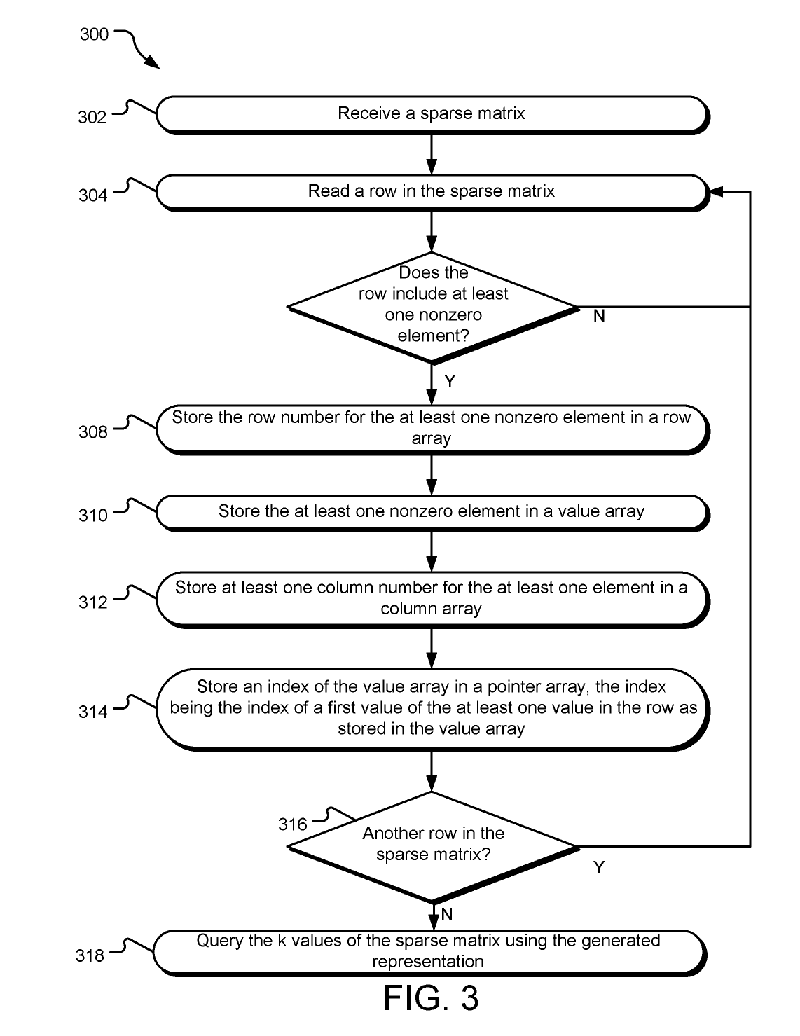

FIG. 3 illustrates example operations 300 for generating a representation of a sparse matrix. The operations 300 may be performed in hardware and/or software of a computing system. In some example implementations, special purpose hardware, such as application specific integrated circuit (ASIC) or system on chip (SoC), performs the operations 300. A receiving operation 302 receives a sparse matrix. A reading operation 304 reads a row in the sparse matrix. A determining operation 306 determines whether the row includes at least one nonzero element (or nonempty element). The determining operation may be performed by reading each element in the row. If the row does not include a nonzero element, then the process returns to the reading operation 304, which reads the next row in the sparse matrix.

If the row includes at least one nonzero element, then a storing operation 308 stores the row number for the at least one nonzero element in a row array. In some example implementations, the storing operation 308 is a concatenate operation, which concatenates the row number to the end of the row array. Another storing operation 310 stores the at least one nonzero element in the value array 310. The storing operation 310 may also be a concatenate operation. Yet another storing operation 312 stores at least one column number corresponding to the at least one element in the column array. The storing operation 312 may also be a concatenate operation.

Another storing operation 314 stores an index of the value array to the pointer array. The index being the index of a value as stored in the value array and being the index of the first value of the at least one value in the current row. Thus, the index of the first value (as stored in the value array) in a row of the sparse matrix is stored for each row. A determining operation 316 determines whether the sparse matrix includes another row. If the sparse matrix includes another row, then the process returns to the reading operation 304, which reads the next row in the sparse matrix. If the sparse matrix does not include another row, then the representation is generated. Thus, a representation of the sparse matrix is generated that includes a value array, column array, pointer array, and row array. The values of the sparse matrix may be queried using the representation in a querying operation 318. The querying operation 318 may be based on one or more processor readable instructions stored in a processor readable memory.

The above described implementations are described with respect to a row specific implementation (e.g., the representation includes a row array that lists nonempty rows). These implementations may also be used to generate a representation using a column specific implementation (e.g., the representation includes a column array that lists nonempty columns). In such an implementation, the representation includes a value array that lists the values, a row array that lists the rows corresponding to the listed values, a pointer array that includes an index of the first value in a specific column as listed in the value array, and a column array that list the nonempty columns.

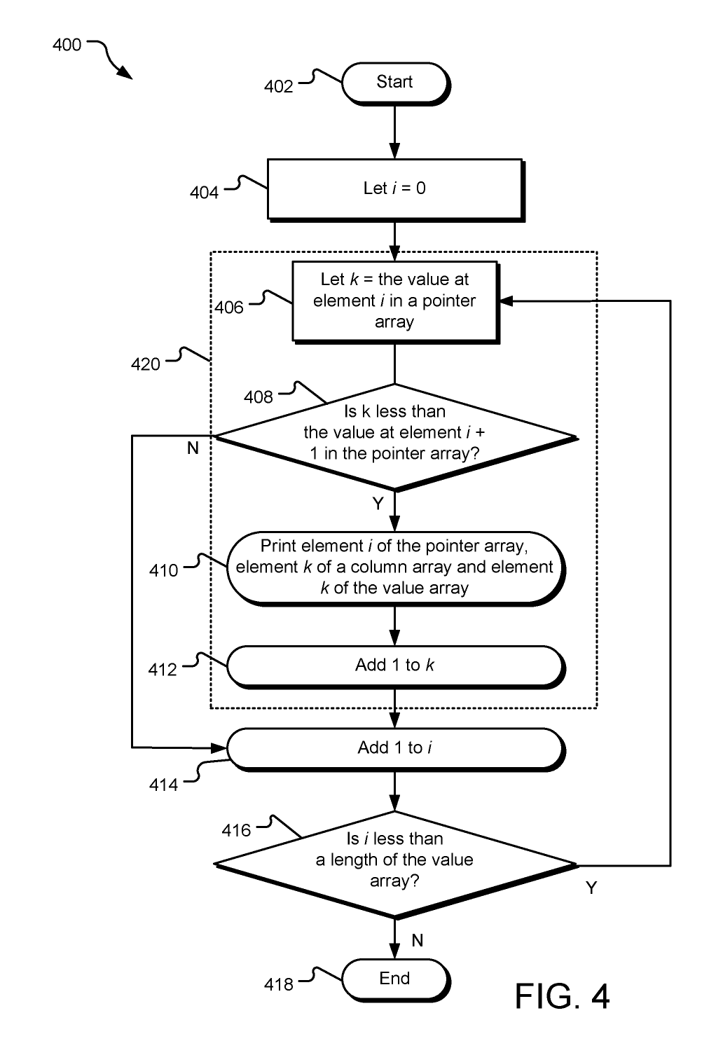

FIG. 4 illustrates example operations 400 for querying a representation of a sparse matrix. Specifically, FIG. 4 illustrates operations for printing values as the values would appear in the sparse matrix from left-to-right and top-to-bottom with rows and columns numbers using the representation described herein. Example code for this process was described above with respect to FIG. 1. The process starts at a starting operation 402. An operation 404 stores 0 at i. At operation 406, k is set to the value at element i in a pointer array (e.g., pointer_array[i]). A determining operation 408 determines whether k is less than the value at element i+1 in the pointer array (e.g., is k<pointer_array[i+1]?). If the value is less than the value at element i+1 of the pointer array, then a printing operation 410 prints element i of the pointer array, element k of the column array (e.g., column_array[k]), and element k of the value array (e.g., value_array[k]). An adding operation 412 adds 1 to k (e.g., k=k+1). If the value k is not less than the value at element i+1 (e.g., greater than or equal to) in the determining operation 408, an adding operation 414 adds 1 to i (e.g., i=i+1).

A determining operation 416 determines whether i is less than the length of the value array (e.g., whether there are any values left). If there are no values left, then an ending operation 418 ends the process. If there are values left in the value array, then the process returns to the operation 406. Thus, operations 420 (e.g., 406, 408, 410, 412) are repeated for each value in the value array.

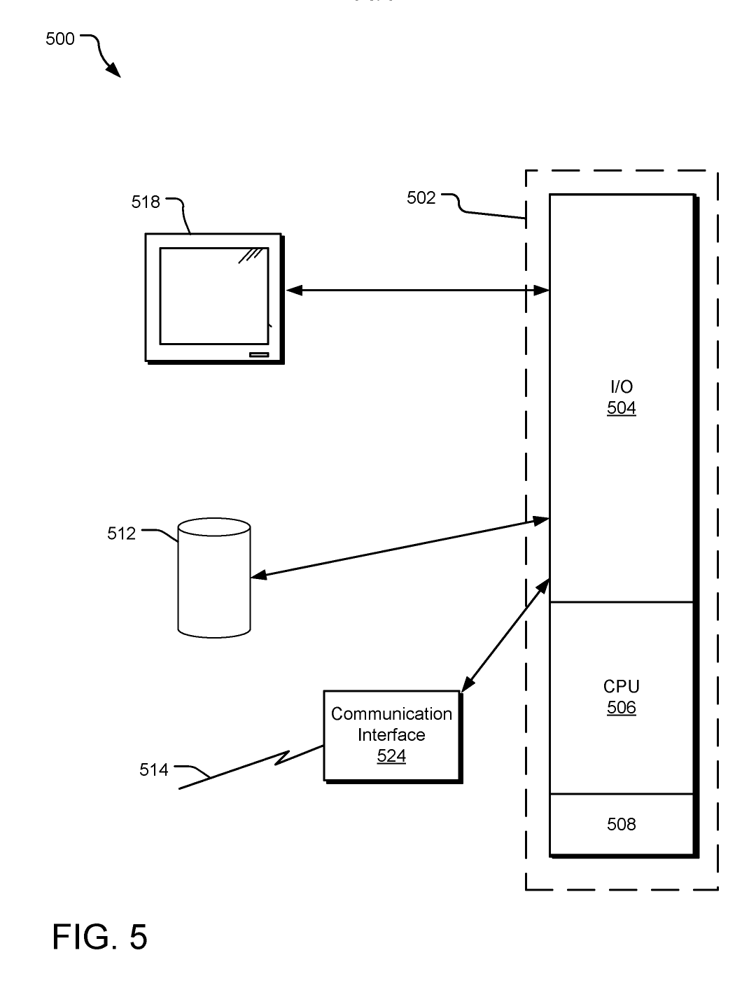

FIG. 5 illustrates an example processing system 500 that may be useful in implementing the described technology. The computer system 500 is capable of executing a computer program product embodied in a tangible computer-readable storage medium to execute a computer process. Data and program files may be input to the computer system 500, which reads the files and executes the programs therein using one or more processors. Some of the elements of a computer system 500 are shown in FIG. 5 wherein a processor 502 is shown having an input/output (I/O) section 504, a Central Processing Unit (CPU) 506, and a memory section 508. There may be one or more processors 502, such that the processor 502 of the processing system 500 comprises a single central-processing unit 506, or a plurality of processing units. The processors may be single core or multi-core processors. The processing system 500 may be a conventional computer, a distributed computer, or any other type of computer. The described technology is optionally implemented in software loaded in memory 508, a disc storage unit 512, and/or communicated via a wired or wireless network link 514 on a carrier signal (e.g., Ethernet, 3G wireless, 5G wireless, LTE (Long Term Evolution)) thereby transforming the processing system 500 in FIG. 5 to a special purpose machine for implementing the described operations. The processing system 500 may be an application specific processing system configured for sparse matrix conversion.

The I/O section 504 may be connected to one or more user-interface devices (e.g., a keyboard, a touch-screen display unit 518, etc.) or a disc storage unit 512. Computer program products containing mechanisms to effectuate the systems and methods in accordance with the described technology may reside in the memory section 504 or on the storage unit 512 of such a system 500.

A communication interface 524 is capable of connecting the computer system 500 to an enterprise network via the network link 514, through which the computer system can receive instructions and data embodied in a carrier wave. When used in a local area networking (LAN) environment, the processing system 500 is connected (by wired connection or wirelessly) to a local network through the communication interface 524, which is one type of communications device. When used in a wide-area-networking (WAN) environment, the processing system 500 typically includes a modem, a network adapter, or any other type of communications device for establishing communications over the wide area network. In a networked environment, program modules depicted relative to the processing system 500 or portions thereof, may be stored in a remote memory storage device. It is appreciated that the network connections shown are examples of communications devices for and other means of establishing a communications link between the computers may be used.

In an example implementation, a user interface software module, a communication interface, an input/output interface module and other modules may be embodied by instructions stored in memory 508 and/or the storage unit 512 and executed by the processor 502. Further, local computing systems, remote data sources and/or services, and other associated logic represent firmware, hardware, and/or software, which may be configured to assist in document governance. A sparse matrix conversion/representation system may be implemented using a general-purpose computer and specialized software (such as a server executing service software), a special purpose computing system and specialized software (such as a mobile device or network appliance executing service software), or other computing configurations. In addition, sparse matrixes, arrays, values, etc. may be stored in the memory 508 and/or the storage unit 512 and executed by the processor 502.

In addition to methods, the embodiments of the technology described herein can be implemented as logical steps in one or more computer systems. The logical operations of the present technology can be implemented (1) as a sequence of processor-implemented steps executing in one or more computer systems and/or (2) as interconnected machine or circuit modules within one or more computer systems. Implementation is a matter of choice, dependent on the performance requirements of the computer system implementing the technology. Accordingly, the logical operations of the technology described herein are referred to variously as operations, steps, objects, or modules. Furthermore, it should be understood that logical operations may be performed in any order, unless explicitly claimed otherwise or unless a specific order is inherently necessitated by the claim language.

Data storage and/or memory may be embodied by various types of storage, such as hard disc media, a storage array containing multiple storage devices, optical media, solid-state drive technology, ROM, RAM, and other technology. The operations may be implemented in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” means a tangible data storage device, including non-volatile memories (such as flash memory and the like) and volatile memories (such as dynamic random access memory and the like). The computer instructions either permanently or temporarily reside in the memory, along with other information such as data, virtual mappings, operating systems, applications, and the like that are accessed by a computer processor to perform the desired functionality. The term “memory” expressly does not include a transitory medium such as a carrier signal, but the computer instructions can be transferred to the memory wirelessly.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A method comprising:
receiving a sparse matrix including r rows, c columns, and k values; and
generating a representation of the sparse matrix, the representation of the sparse matrix including at least a row array, each element of the row array indicating a row number of the r rows of the sparse matrix that includes at least one of the k values.

2. The method of claim 1 wherein the generated representation of the sparse matrix further includes:
a value array including k elements, each element of the value array being one of the k values of the sparse matrix;
a column array including k elements, each element corresponding to an element of the value array and indicating a column in the sparse matrix where the corresponding element of the value array is located; and
a pointer array, each element of the pointer array indicating an element in the value array that starts a new row in the sparse matrix.

3. The method of claim 2 wherein the generating operation further comprises:
for each row i in the r rows, if the row i includes at least one nonzero element:
storing i in the row array;
storing the at least one value in the value array;
storing a column number j in the column array, the column number j being a column number of the c columns where the at least one value is located in the sparse matrix; and
storing an index of the value array in the pointer array, the index being the index of a first value of the at least one value in the row i as stored in the value array.

4. The method of claim 2 wherein the pointer array includes p elements wherein p is a number of non-empty rows in the sparse matrix plus one.

5. The method of claim 2 wherein the row array includes p elements, wherein p is a number of non-empty rows in the sparse matrix plus one.

6. The method of claim 1 further comprising:
querying the k values of the sparse matrix using the generated representation of the sparse matrix.

7. The method of claim 1 further comprising:
storing the generated representation of the sparse matrix in a memory for operation on the values of the sparse matrix using the representation.

8. One or more processor-readable storage media encoding processor-executable instructions for executing on a computer system a computer process, the computer process comprising:
receiving a sparse matrix including r rows, c columns, and k values; and
generating a representation of the sparse matrix, the representation of the sparse matrix including at least a row array, each element of the row array indicating a row of the r rows of the sparse matrix that includes at least one of the k values.

9. The one or more processor-readable storage media of claim 8 wherein the generated representation of the sparse matrix further includes:
a value array including k elements, each element of the value array being one of the k values of the sparse matrix;
a column array including k elements, each element corresponding to an element of the value array and indicating a column in the sparse matrix where the corresponding element of the value array is located; and
a pointer array, each element of the pointer array indicating an element in the value array that starts a new row in the sparse matrix.

10. The one or more processor-readable storage media of claim 9 wherein the generating operation further comprises:
for each row i in the r rows, if the row i includes at least one nonzero element:
storing i in the row array;
storing the at least one value in the value array;
storing a column number j in the column array, the column number j being a column number of the c columns where the at least one value is located in the sparse matrix; and
storing an index of the value array in the pointer array, the index being the index of a first value of the at least one value in the row i as stored in the value array.

11. The one or more processor-readable storage media of claim 9 wherein the pointer array includes p elements wherein p is a number of non-empty rows in the sparse matrix plus one.

12. The one or more processor-readable storage media of claim 9 wherein the row array includes p elements wherein p is a number of non-empty rows in the sparse matrix plus one.

13. The one or more processor-readable storage media of claim 8 further comprising:
querying the k values of the sparse matrix using the generated representation of the sparse matrix.

14. The one or more processor-readable storage media of claim 8 further comprising:
storing the generated representation of the sparse matrix in a memory for operation on the values of the sparse matrix using the representation.

15. A system comprising:
a processor readable memory storing a sparse matrix including r rows, c columns, and k values; and
one or more processors configured to access the processor readable memory to generate a representation of the sparse matrix including at least a row array, each element of the row array indicating a row of the r rows of the sparse matrix that includes at least one of the k values.

16. The system of claim 15 wherein the generated representation further includes:
a value array including k elements, each element of the value array being one of the k values of the sparse matrix;
a column array including k elements, each element corresponding to an element of the value array and indicating a column in the sparse matrix where the corresponding element of the value array is located; and
a pointer array, each element of the pointer array indicating an element in the value array that starts a new row in the sparse matrix.

17. The system of claim 16 wherein the one or more processors are configured to generate the representation by:
for each row i in the r rows, if the row i includes at least one nonzero element:
storing i in the row array;
storing the at least one value in the value array;
storing a column number j in the column array, the column number j being a column number of the c columns where the at least one value is located in the sparse matrix; and
storing an index of the value array in the pointer array, the index being the index of a first value of the at least one value in the row i as stored in the value array.

18. The system of claim 16 wherein the pointer array includes p elements wherein p is a number of non-empty rows in the sparse matrix plus one.

19. The system of claim 16 wherein the row array includes p elements wherein p is a number of non-empty rows in the sparse matrix plus one.

20. The system of claim 16 wherein the one or more processors are configured to query the generated representation of the sparse matrix based on processor readable instructions stored in the memory.
